(19) United States
(12) Patent Application Publication
(10) Pub. No.: US 2010/0325118 A1
(43) Pub. Date: Dec. 23, 2010

(54) TEXT INFORMATION ANALYSIS SYSTEM

(76) Inventor: Yoshikazu Takemoto, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/735,618

(22) PCT Filed: Feb. 12, 2009
(86) PCT No.: PCT/JP2009/052269

§ 371 Date: Aug. 3, 2010

(30) Foreign Application Priority Data
Feb. 15, 2008 (JP) 2008-034385

(51) Int. Cl. G06F 17/30

(52) U.S. Cl. 707/758; 707/E17.009

(57) ABSTRACT

A first problem is that a cause investigation has been difficult to achieve in related art, though it is important to analyze the cause of a sudden increase/sudden decrease (burst). For example, a person needs to interpret the contents by carefully reading the original text of an article during that period, which requires an operating time. The cause of a burst has not been found in many cases. This is because an event unknown to a user may be the cause. A text information analysis system includes a time expression determination section 21, a date/time expression storage section 22, a date/time calculation section 23, a schedule information creation section 24, a schedule information storage section 25, and a feature expression extraction section 26, and operates so as to automatically extract schedule information (date/time expression and feature expression), such as an implementation date of a campaign or an event, or an occurrence date of an incident, from data to be analyzed or data associated with the data (Web news and the like).

### TECHNICAL FIELD

The present invention relates to a text information analysis system, and particularly relates to a system, a method, and a program for achieving an analysis service by analyzing information (Consumer Generated Media, hereinafter referred to as “CGM”) published on the Internet, such as blogs or SNS (Social Networking Service) to provide an analysis result or a report for measurement of campaign effectiveness, marketing research, or brand research.

### BACKGROUND ART

As a basic analysis about CGM, there is known a function or an analyzing menu for entering and setting a keyword to be analyzed (target keyword) to report the time series variation in the number of posts as a graph. Upon sudden increase in topics when a new product or campaign is posted, a user can see the amount of interest from the analysis result. Meanwhile, upon sudden increase in topics when an irregularity occurs in a company, a user can see how many days it takes to calm down the situation, for example. There is known an eHyouban/mining service or the like as an actual CGM analysis service (press release “start of enterprise blog information analysis service [eHyouban/mining service]”, http://www.nec.co.jp/press/ja/0707/0201.html).

Here, it is important to analyze a cause of a sudden increase/sudden decrease (burst) in the graph. In the related CGM analysis system, a user can confirm it by clicking the time series graph to display the entire original text at that point. However, a person needs to interpret the contents by carefully reading the original text of an article during that period. It takes man hours when the amount of the original text is huge, and cause investigation is difficult to achieve.

It is often the case that the cause of burst is linked with implementation of a campaign or operation of an event, an incident occurrence, or the like. In this regard, there is known a method of preliminarily entering schedule or calendar information, such as an implementation date of a campaign or an event, or a date of incident occurrence, which may cause the burst, and performing causal analysis with reference to the information. This method involves analysis based on given information to confirm an effect or an influence of an expected event.

The related CGM analysis system shown in FIG. 7 includes a data storage section 10, a text analysis section 11, a document sort section 12, a document number counting section 13, a result visualization section 14, and an original text reference section 15.

The related CGM analysis system having such a configuration operates as follows. That is to say, the text analysis section 11 executes a text analysis on text data such as a blog article stored iii the data storage section 10. Specifically, the text analysis section 11 performs a morpheme analysis processing, a dependency parsing processing, or the like. The morpheme analysis processing is a processing that divides text data in the data storage section 10 into words using a word dictionary and adds with word-class information to each word. In particular, the technique is generally applied to the case of computerizing a language where words are not separated with a space, such as Japanese, as disclosed in Non-Patent Document 1, for example. The dependency parsing processing is a technique that determines a modification relation (relation between a subject and a verb, relation between a modifying word and a modificand, in a sentence) and the like in a sentence. The technique is disclosed in Patent Document 1, Patent Document 2, Non-Patent Document 2, and the like.

The document sort section 12 is a section that sorts out articles including a keyword to be analyzed (target keyword) in the result (which is obtained by dividing a sentence into words) of the sentence analysis section 11. The target keyword is entered and set by the user. All articles are classified into articles including the target keyword and articles not including the target keyword.

The document number counting section 13 is a section that counts the number of articles sorted out by the document sort section 12. The result visualization section 14 visualizes and presents a count result of the document number counting section 13 as a time series graph or the like.

The original text reference section 15 is a section that refers to a portion specified with a click operation or the like by the user on the result visualization section 14, that is, an original text view on a specified date/time in the time series graph.
[Patent Document 1] Japanese Unexamined Patent Application Publication No. 2000-172691
[Patent Document 2] Japanese Unexamined Patent Application Publication No. 2001-84250
[Non-Patent Document 1] “Data-Structure of a Large Japanese Dictionary and Morphological Analysis by Using It”, Makoto Nagao et. al., Information Processing, Vol. 19, No. 6, 1978
[Non-Patent Document 2] “Automatic Segmentation Method for Compound Words Using Semantic Dependent Relationships between Words”, Journal of Information Processing Society of Japan, Masahiro Miyazaki, Vol. 25, No. 6, 1984

### DISCLOSURE OF INVENTION

### Technical Problem

A first problem is that a cause investigation has been difficult to achieve in related art, though it is important to analyze the cause of a sudden increase/sudden decrease (burst). For example, a person needs to interpret the contents by carefully reading the original text of an article during that period, which requires an operating time.

An object of this invention is to provide a CGM analysis system capable of making it easier to understand a causal analysis on a sudden increase/sudden decrease (burst) in a graph, and capable of performing the analysis rapidly and efficiently.

### Technical Solution

A text information analysis system (CGM analysis system) according to the present invention includes a time expression determination section 21, a schedule information creation section 24, a schedule information storage section 25, and a feature expression extraction section 26. The text information analysis system may further include a date/time expression storage section 22 and a date/time calculation section 23. This configuration enables operation for automatically extracting schedule information such as an implementation date of a campaign or an event, or a date of incident occurrence (a date/time expression or a feature expression) from data to be analyzed or related data thereof (web news or the like). The object of this invention can be achieved by adopting such a configuration and by presenting a part of the schedule information including the burst, when an analysis result (a graph) is displayed.

### ADVANTAGEOUS EFFECTS

A first effect is that causal analysis of a burst is effectively performed by making it possible to reference a burst part and schedule information, such as a campaign, an event, or an incident, which are automatically extracted.

### BRIEF DESCRIPTION OF DRAWINGS

FIG. 1 is a block diagram showing a configuration of a first exemplary embodiment of this invention;

FIG. 2 is a flow chart showing an operation of the first exemplary embodiment;

FIG. 3 is a block diagram showing a configuration of a second exemplary embodiment of this invention;

FIG. 4A is a specific example (an example of original text) of an operation of a preferred exemplary embodiment to carry out a first invention;

FIG. 4B is a specific example (an example of a result of text analysis) of an operation of a preferred exemplary embodiment to carry out the first invention;

FIG. 4C is a specific example (an example of schedule information) of an operation of a preferred exemplary embodiment to carry out the first invention;

FIG. 5A is a second specific example (an example of original text) of an operation of a preferred exemplary embodiment to carry out the first invention;

FIG. 5B is a second specific example (an example of a result of text analysis) of an operation of a preferred exemplary embodiment to carry out the first invention;

FIG. 5C is a second specific example (an example of contents of a date/time expression storage section) of an operation of a preferred exemplary embodiment to carry out the first invention;

FIG. 5D is a second specific example (an example of schedule information) of an operation of a preferred exemplary embodiment to carry out the first invention;

FIG. 6 is a diagram showing an operation of a system; and

FIG. 7 is a block diagram showing a configuration of a related apparatus.

### EXPLANATION OF REFERENCE

10 DATA STORAGE SECTION
11 TEXT ANALYSIS SECTION
12 DOCUMENT SORT SECTION
13 DOCUMENT NUMBER COUNTING SECTION
14 RESULT VISUALIZATION SECTION
15 ORIGINAL TEXT REFERENCE SECTION
21,21A TIME EXPRESSION DETERMINATION SECTION
22 DATE/TIME EXPRESSION STORAGE SECTION
23 DATE/TIME CALCULATION SECTION
24 SCHEDULE INFORMATION CREATION SECTION
25 SCHEDULE INFORMATION STORAGE SECTION
26 FEATURE EXPRESSION EXTRACTION SECTION
27 SCHEDULE INFORMATION DISPLAY SECTION

### BEST MODE FOR CARRYING OUT THE INVENTION

Next, an exemplary embodiment for carrying out the invention will be explained in detail with reference to the drawings.

### First Exemplary Embodiment

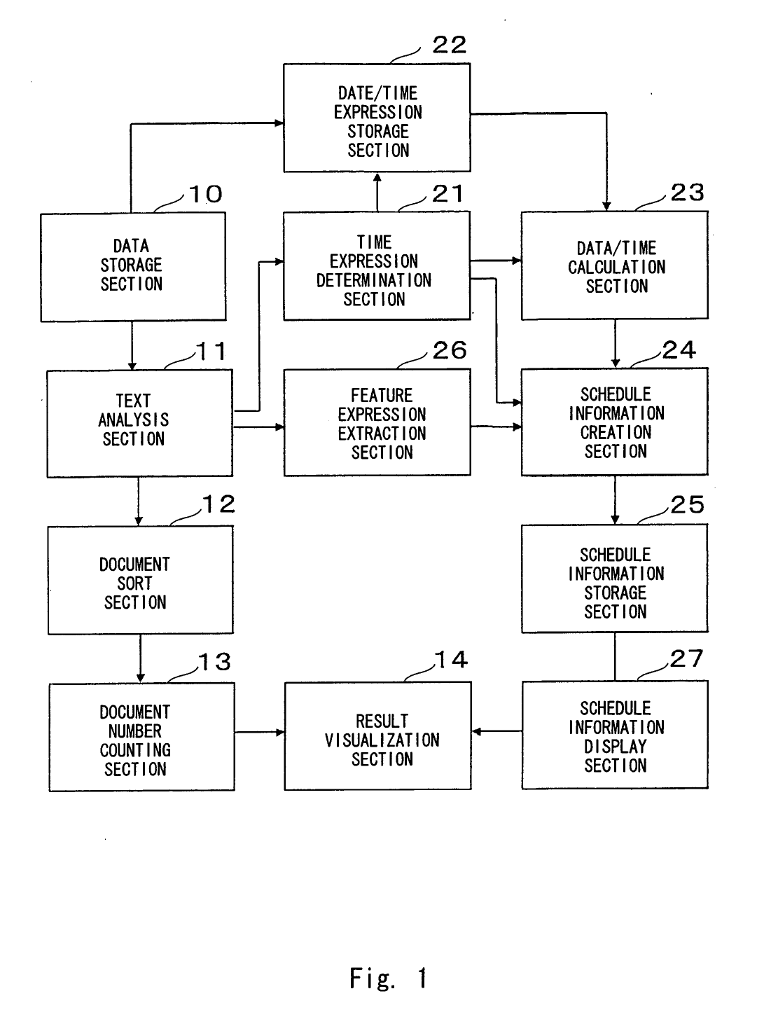

Referring to FIG. 1, a first exemplary embodiment of this invention includes a data storage section 10, a text analysis section 11, a document sort section 12, a document number counting section 13, a result visualization section 14, a time expression determination section 21, a date/time expression storage section 22, a date/time calculation section 23, a schedule information creation section 24, a schedule information storage section 25, a feature expression extraction section 26, and a schedule information display section 27.

The outline of operations of components ranging from the data storage section 10 to the result visualization section 14 is the same as that described in the Background Art section.

Each of these sections operates as outlined below.

The time expression determination section 21 determines and extracts a time expression from a result of the text analysis section 11. The time expression refers to an expression including a unit to represent date/time (a date/time expression) such as “nen” (year), “tsuki” (month), “hi” (date), “ji” (hour), or “fun” (minute), or a proper word to represent (proper expression for time) time such as “sakujitsu” (yesterday), “kotoshi” (this year), “getsuyoubi” (Monday), “sensyuu” (last week), or “syougo” (noon). The date/time expression may represent a direct date/time. The proper expression for time may represent a relative date/time.

The date/time expression can be determined by pattern matching of “numeral+time expression”, such as “1 gatsu 1 nichi” (January 1st) according to a string of words with word-class information in a result of the text analysis section 11. The proper expression for time can be determined by preliminarily registering words such as “yesterday”, “this year”, “Monday”, “last week”, and “noon” as words representing the proper expression for time.

The date/time expression storage section 22 stores time series information (time stamp information such as a text creation date or an article posting date) of text data stored in the data storage section 10, or the date/time expression extracted by the time expression determination section 21.

The date/time calculation section 23 calculates an actual date/time expression to replace the proper expression for time such as “sakujitsu” (yesterday) or “sensyuu getsuyoubi” (last Monday), based on the time stamp information or the date/time expression stored in the date/time expression storage section 22. For example, assuming that the article posting date is “2008 nen 1 gatsu 1 nichi” (Jan. 1, 2008), the time expression “sakujitsu” (yesterday) is replaced by the actual date/time expression “2007 nen 12 gatsu 1 nichi” (Dec. 31, 2007). The time expression “sensyuu getsuyoubi” (last Monday) is replaced by “2007 nen 12 gatsu 24 nichi” (Dec. 24, 2008) that falls on the last Monday.

The feature expression extraction section 26 determines and extracts a feature expression from the result of text analysis section 11. Here, the feature expression refers to an important word (keyword) in the text. The feature expression is selected (filtered) depending on the word class information, which is added as a result of the text analysis section 11, such as a noun (a general noun, a proper noun), a verb, or an adjective. Alternatively, the feature expression is selected focusing on a word representing holding of a campaign or an event, such as “launching”, “release”, “holding”, or “in operation”, or a word representing occurrence of an incident, such as “disclosure”. Examples of proper nouns include geographical names, organization names, personal names, and product names. Determination of proper nouns in the feature expression extraction section 26 is achieved by registering proper nouns in the word dictionary of the text analysis section 11 or by pattern matching depending on affixes, such as “kabushikikaisya” (company) of “AAA kabushikikaisya” as an organization name, “kikou” (institution) of “BBB kikou”, or “shi” (Mr.) of “CCC shi” as a personal name (see, “A Japanese Named Entity Extraction System Based on Building a Large-scale and High-quality Dictionary and Pattern-matching Rules” Takemoto et. al., Journal of Information Processing Societies of Japan, Vol. 42, No. 6, 2001).

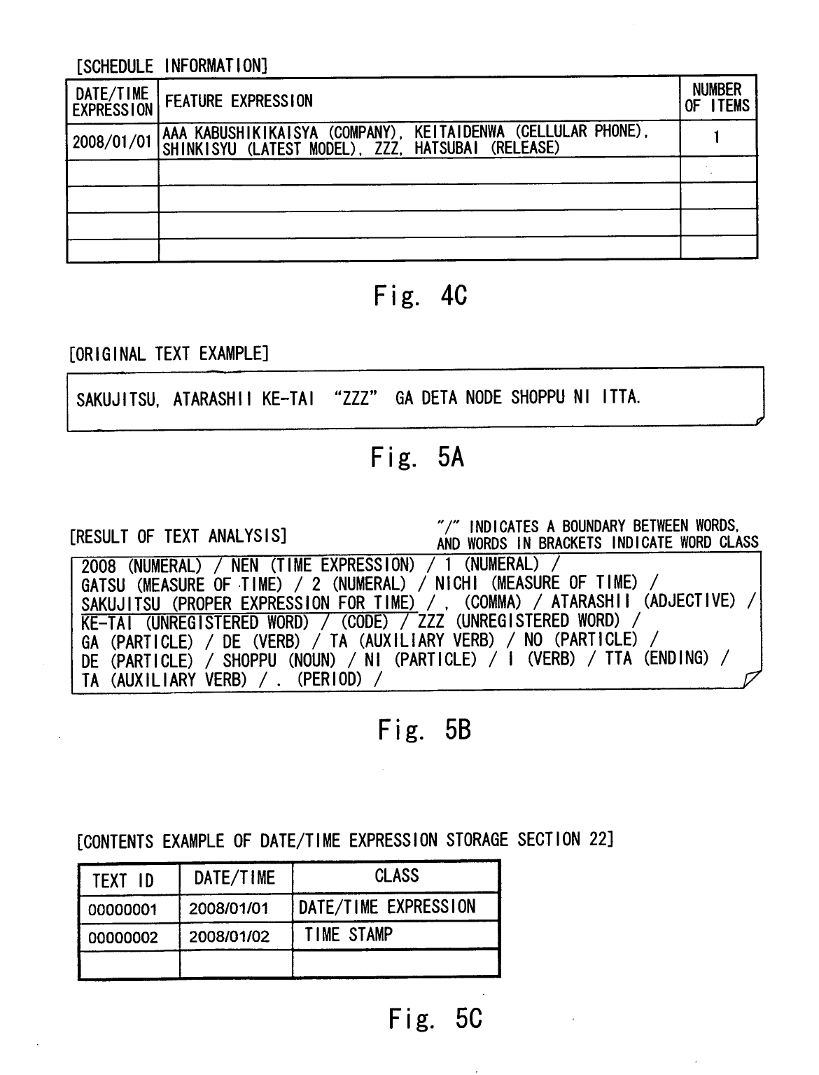

The schedule information creation section 24 creates the schedule information using an output result of the time expression determination section 21 or an output result of the date/time calculation section 23, and an output result of the feature expression extraction section 26. The schedule information is composed of the date/time expression determined by the time expression determination section 21 or the date/time expression calculated by the date/time calculation section 23, and one or more feature expressions determined by the feature expression extraction section 26. The schedule information is tabular information including an index composed of the date/time expressions (year, month, date, etc) as shown in FIG. 4C. Schedule information items including the same feature expression for the same date/time expression are merged and number-of-item information is added thereto.

The schedule information storage section 25 stores a result (the schedule information and the number-of-item information) created by the schedule information creation section 24.

The schedule information display section 27 is a section on which the date and time of the schedule information requested by a user is specified, entered, and displayed. The schedule information display section 27 sorts the contents of the schedule information storage section 25 in the order of the number-of-item information or in the order of the number of the feature expressions and displays the result on the result visualization section 14.

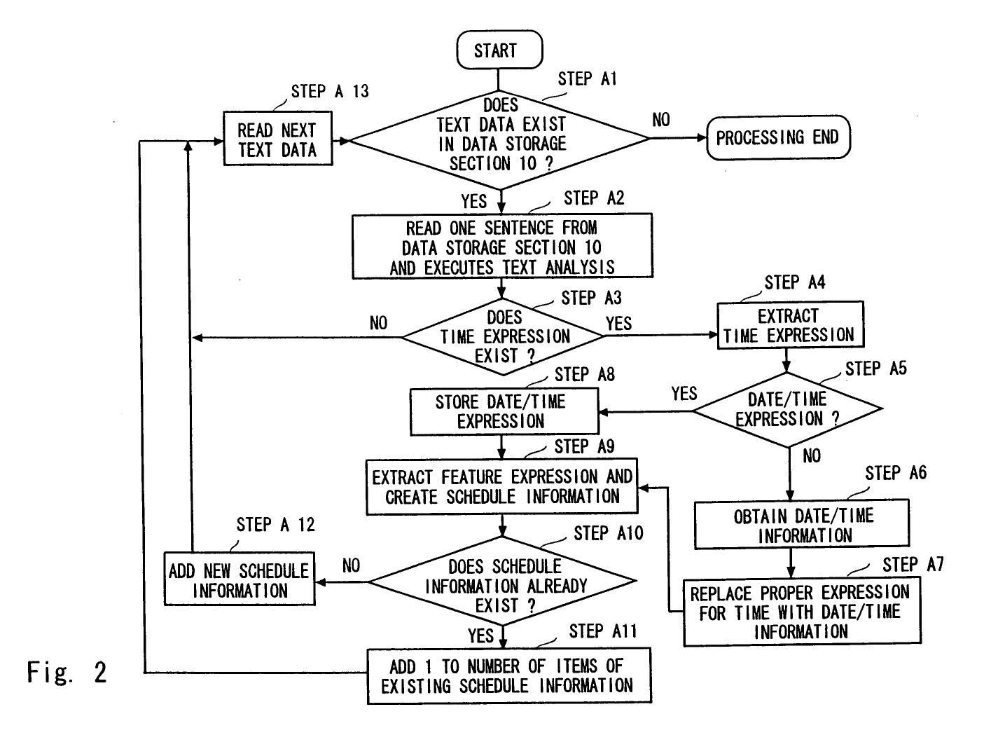

Next, the overall operation of this exemplary embodiment will be explained referring to FIG. 1 and the flow chart of FIG. 2.

First, when the data storage section 10 stores data (step A1 in FIG. 2), the text analysis section 11 reads one sentence of text data from the data storage section 10 and executes sentence analysis (step A2). Here, an example is described in which the text data is processed per sentence. However, the unit of processing for text data is not limited thereto. Text data may be processed per paragraph or article, for example.

When the result of the text analysis includes the time expression (step A3), the time expression determination section 21 extracts the time expression (step A4). The time expression determination section 21 determines whether the time expression extracted in step A4 is the date/time expression or not (step A5). Specifically, the time expression determination section 21 extracts the date/time expression and the proper expression for time as the time expression. When the time expression extracted is the date/time expression, the time expression determination section 21 stores the date/time expression to the date/time information storage section 22 (step A8). At this time, the time expression determination section 21 detects the time stamp information (time series information of the text data), such as a text creation date or an article posting date, and stores it to the date/time information storage section 22.

When the time expression extracted in step A4 is not the date/time expression (that is to say, it is the proper expression for time), the date/time calculation section 23 first obtains the date/time expression stored in the date/time expression storage section 22 (step A6). The method of obtaining the date/time expression is preliminarily defined as a rule. The rule is, for example, obtaining time stamp information such as an article posting date/time in the date/time expression storage section 22, or obtaining the last registered information in the date/time expression storage section 22 (that is, date/time is calculated based on the date/time expression that appears nearest to the proper expression for time). Next, the date/time calculation section 23 calculates date/time based on the date/time expression obtained in step A6 for the proper expression for time extracted in step A4 and replaces the proper expression for time by the date/time expression (step A7).

Subsequently, the feature expression extraction section 26 extracts the feature expression. The schedule creation section 24 creates the schedule information (step A9).

It step A10, determination is made as to whether the schedule information created in step A9 (a set of the date/time expression and the feature expression) is included in the schedule information already created. When the same schedule information already exists, the number-of-item information indicating the existing schedule information is incremented by one (step A11). When no existing record is found, the schedule information created in step A9 is added to the schedule information as new schedule information (step A12).

The aforementioned flow is repeated until no more text data exists in step A1. Then, the created schedule information and number-of-item information are stored to the schedule information storage section 25. The result visualization section 14 displays the schedule information corresponding to the date/time specified on the schedule information display section 27.

### Second Exemplary Embodiment

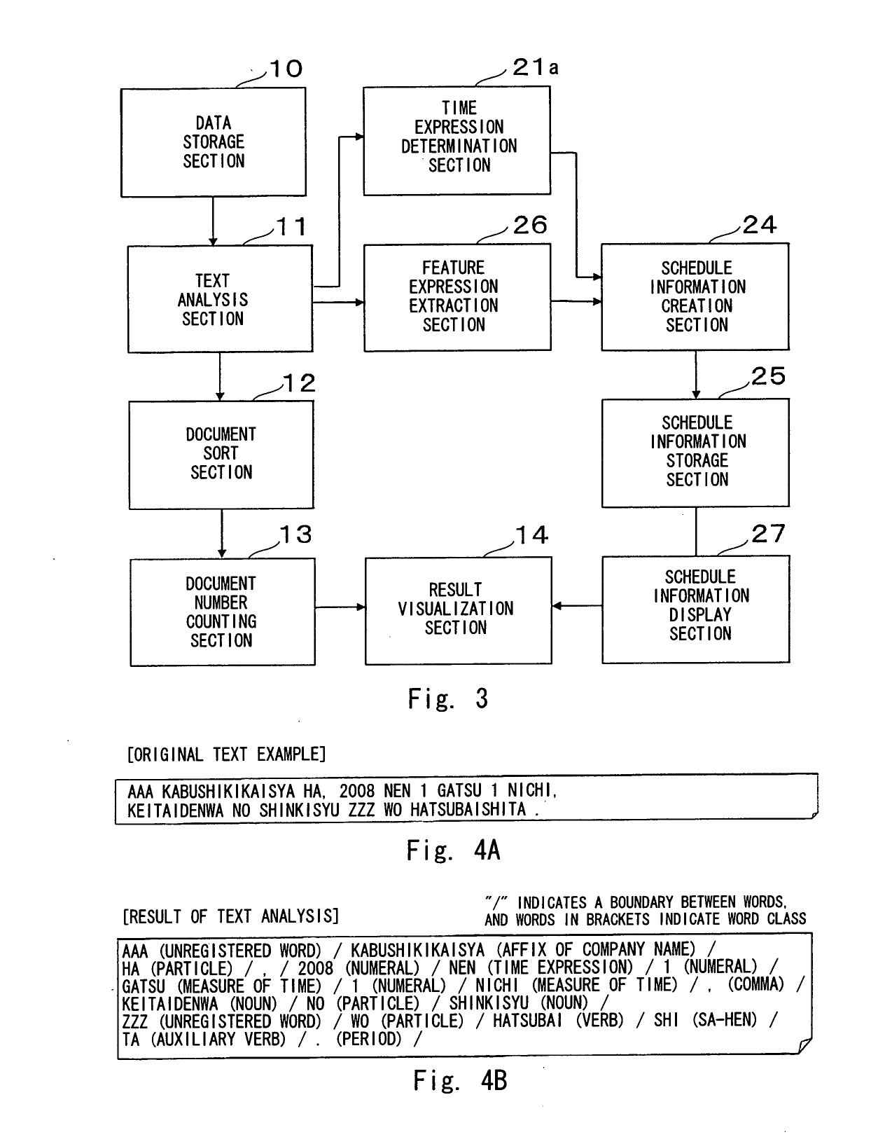

FIG. 3 is a block diagram showing a configuration of a second exemplary embodiment. The text information analysis system of FIG. 2 corresponds to the configuration of FIG. 1, except that the date/time expression storage section 22 and the date/time calculation section 23 are omitted. Further, a time expression determination section 21a determines and extracts a date/time expression as a time expression. In this exemplary embodiment, the time expression determination section 21a does not carry out the determination and extraction of the proper expression for time. Alternatively, the time expression determination section 21a may determine and extract the proper expression for time. In this instance, the time expression determination section 21a preliminarily holds a proper expression for time in its own memory, and determines the proper expression for time based on this. Further, the schedule information may be a combination of a time stamp and the proper expression for time to be displayed. Other components are the same as those of FIG. 1, and thus the explanations thereof are omitted.

The text information analysis system of this exemplary embodiment carries out step A8 subsequent to step A4 in the operation of the flow chart shown in FIG. 2. Steps 5 to A7 are not carried out. Other operations are the same as those of FIG. 2, and thus the explanations thereof are omitted.

### Other Exemplary Embodiment

Functions implemented by the components of the text information analysis system shown in FIG. 1 or 3 can be achieved by a program. The program can be stored to a computer-readable recording medium. The program is loaded into a memory of a computer, and is then executed under control of a CPU (Central Processing Unit).

Next, effects of these exemplary embodiments will be explained.

These exemplary embodiments are configured to automatically create the schedule information from the text data. Therefore, by referring to this by the user, it is possible to effectively analyze a relationship between a part of a sudden change in a graph and an unknown campaign, an unknown event, an unknown incident, or the like.

Heretofore, merely an expected event such as known event information or known campaign information is obtained. The cause of a burst has not been found in many cases. This is because an event unknown to the user may be the cause.

In this regard, according to an exemplary embodiment of this invention, there is provided a CGM analysis system capable of grasping an unexpected event such as unknown event information or incident.

Accordingly, this enables matching with an unknown campaign, event, incident, or the like to thereby find an unexpected cause (for example, in the case where a burst occurs when “an irregularity” takes place, but an analyst does not know the cause.). On the other hand, it is also possible to figure out that an unknown campaign, event, incident, or the like is not the cause of the sudden increase in the number of topics, that is, there is no effect of the campaign or no influence of the incident.

### Mode for the Invention

FIG. 4 show a specific example of an operation of a preferred exemplary embodiment for carrying out a first invention.

FIG. 4A shows an example of original text. FIG. 4B shows an example of a result of the text analysis.

For text data “AAA kabushikikaisya ha, 2008 nen 1 gatsu 1 nichi, keitaidenwa no shinkisyu ZZZ wo hatsubaishita.” (AAA company released the latest model of cellular phones on Jan. 1, 2008), which is stored in the data storage section 10, the text analysis section 11 outputs a text analysis result indicating that “AAA (unregistered word)/kabushikikaisya (affix of company name)/ha (particle)/, /2008 (numeral)/nen (time expression)/1 (numeral)/gatsu (measure of time)/1 (numeral)/nichi (measure of time)/, (comma)/keitaidenwa (noun)/no (particle)/shinkisyu (noun)/ZZZ (unregistered word)/wo (particle)/hatsubai (verb)/shi (sa-hen)/to (auxiliary verb)/. (period)”.

In this example, a pattern of “numeral+measure of time”, like “/2008 (numeral)/nen (time expression)/”, “/1 (numeral)/gatsu (measure of time)/”, and “/1 (numeral)/nichi (measure of time)/” is included in the result of the text analysis. Thus, the time expression determination section 21 determines and extracts “2008 nen (year) 1 gatsu (month) 1 nichi (day)” (Jan. 1, 2008) as the date/time expression.

The feature expression extraction section 26 extracts nouns, verbs, unregistered words, etc, such as “AAA (unregistered word)”, “kabushikikaisya (affix of company name)”, “keitaidenwa (noun)”, “shinkisyu (noun)”, “ZZZ (unregistered word)”, and “hatsubai (verb)” from the result of the text analysis. The unregistered words are words that are not registered in the word dictionary of the text analysis section 11. It is highly possible that the unregistered words are proper nouns such as a model name “ZZZ” of a cellular phone. Consequently, the unregistered words are also extracted as the feature expression. Further, the feature expression extraction section 26 determines and extracts a pattern of “unregistered word+affix of company name”, such as “ZZZ (unregistered word)”, and “kabushikikaisya (affix of company name)”, as a company name (organization name).

Then, the schedule information creation section 24 creates tabulated schedule information as shown in FIG. 4C

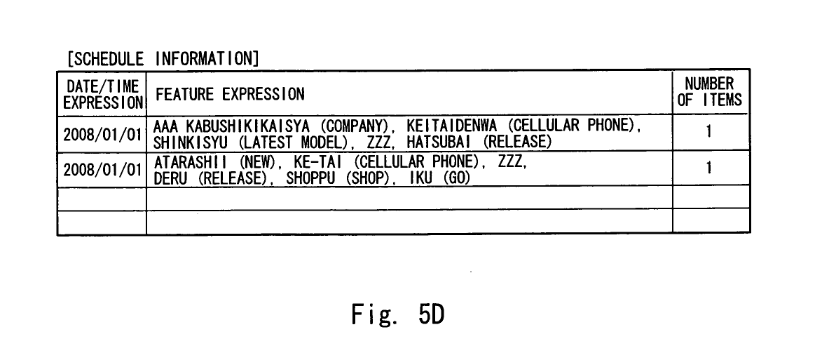

FIG. 5 show a second specific example of an operation of a preferred exemplary embodiment for carrying out the first invention.

FIG. 5A shows an example of original text. FIG. 5B shows an example of a result of the text analysis.

In FIG. 5B, the word “sakujitsu” (yesterday) is determined as the proper expression for time as a result of the text analysis. Thus, the date/time calculation section 23 calculates the date time expression from the contents of the date/time expression storage section 22.

FIG. 5C shows an example of the contents of the date/time expression storage section 22. They are composed of “text ID”, “date/time”, and “class”. The “text ID” is an identifier to identify text uniquely. The “date/time” is date/time information corresponding to the text ID. The “class” is source information of the date/time information. Information “time stamp” is added to the time stamp information which is added to the data storage section 10, or information “date/time information” is added to determination information of this invention.

In this example, “time stamp” is included in “information for acquisition and determination”. Thus, date/time of “sakujitsu” (yesterday) is calculated based on the date/time expression “2008 nen 1 gatsu 2 nichi” (Jan. 2, 2008), resulting in “2008 nen 1 gatsu 1 nichi” (Jan. 1, 2008). As a result, schedule information as shown in FIG. 5D is created. Even if there is a rule to obtain the one that is last registered in the date/time expression storage section 22, similar processing is executed.

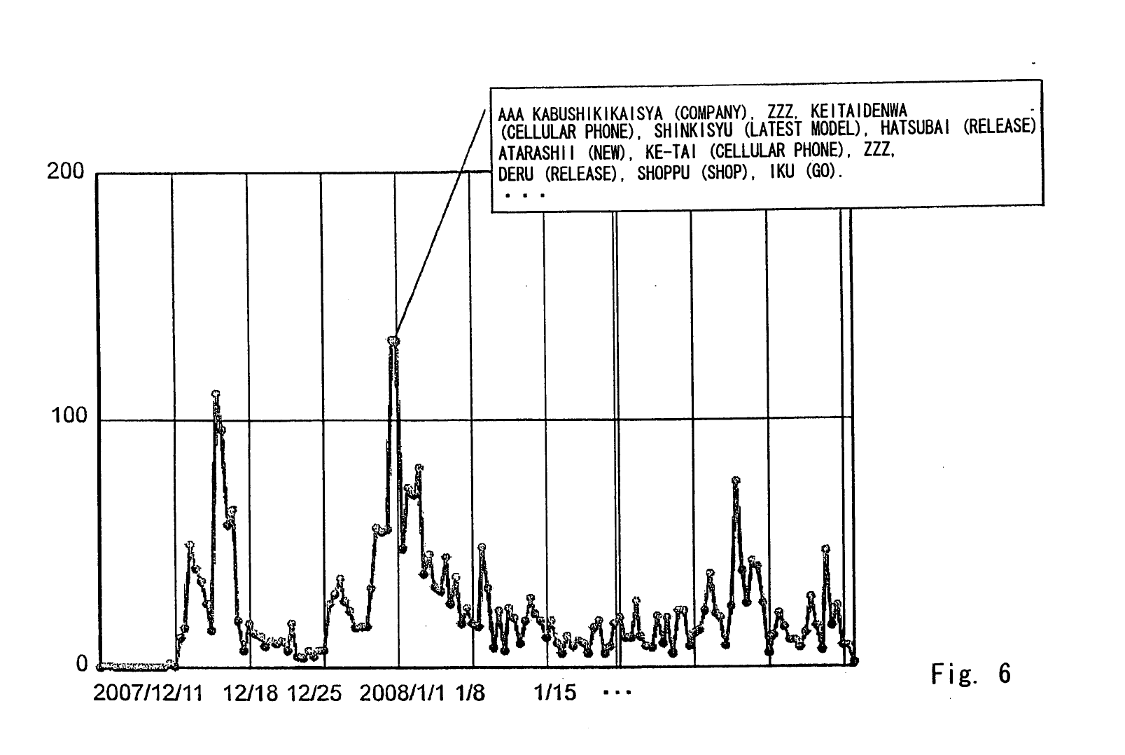

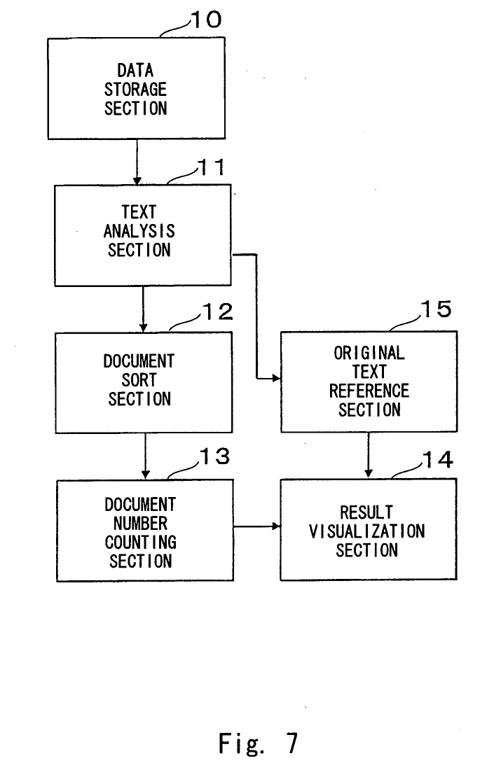

FIG. 6 shows an example of system operations in which a time series graph is displayed on the result visualization section 14, and upon a click operation at a remarkable point on the graph, schedule information corresponding to the date/time is presented.

As described above, the invention of this application is explained with reference to the exemplary embodiments and the examples, but the invention of this application is not limited to the exemplary embodiments and the examples. The configurations or the details of the invention of this application may be practiced with various modifications that those skilled in the art will recognize within the scope of the invention of this application.

This application is based upon and claims the benefit of priority from Japanese patent application No. 2008-034385, filed on Feb. 15, 2008, the disclosure of which is incorporated herein its entirety by reference.

### INDUSTRIAL APPLICABILITY

The present invention is applicable to systems that achieve an analysis service by analyzing writing information (Consumer Generated Media) via the Internet, such as blogs published on the Internet, or SNS (Social Networking Service), to provide an analysis result or a report for measurement of campaign effectiveness, marketing research, or brand research.

This invention is applicable not only to article published on the Internet, but also to an intended purpose, like analysis of text data including time series information (analysis service utilizing technique of text mining).

1. A text information analysis system comprising:
a data storage section that stores data to be analyzed;
a text analysis section that performs text analysis on text data in the data storage section;
a document sort section that sorts out articles including a keyword to be analyzed in a result of the text analysis section;
a document number counting section that counts a number of articles sorted out by the document sort section;
a result visualization section that visualizes and presents a count result of the document number counting section as a time series graph or the like;
a time expression determination section that determines and extracts a date/time expression or a proper expression for time from the result of the text analysis section;
a feature expression extraction section that determines and extracts a feature expression which distinctively appears in the articles including the keyword from the result of the text analysis section;
a schedule information creation section that creates schedule information including a set of the date/time expression and one or more feature expressions based on an output result of the time expression determination section and an output result of the feature expression extraction section;
a schedule information storage section that stores a result created by the schedule information creation section; and
a schedule information display section that obtains schedule information corresponding to date and time specified by a user in the schedule information storage section, and displays it on the result visualization section.

2. The text information analysis system according to claim 1, further comprising:
a date/time expression storage section that stores time stamp information such as a text creation date or an article posting date of the text data stored in the data storage section, or the date/time expression extracted by the time expression determination section; and
a date/time calculation section that calculates an actual date/time expression to replace the proper expression for time extracted by the time expression determination section, based on the time stamp information or the date/time expression stored in the date/time expression storage section.

3. The text information analysis system according to claim 2, wherein
the proper expression for time is a word indicating relative date/time, and
the date/time calculation section replaces the proper expression for time with a straightforward date/time expression by using the time stamp information such as the text creation date or the article posting date of the text data stored in the data storage section.

4. A text information analysis system comprising:
a data storage section that stores data to be analyzed;
a text analysis section that performs text analysis on text data in the data storage section;
a document sort section that sorts out articles including a keyword to be analyzed in a result of the text analysis section;
a document number counting section that counts a number of articles sorted out by the document sort section;
a result visualization section that visualizes and presents a count result of the document number counting section as a time series graph or the like;
a time expression determination section that determines and extracts a date/time expression or a proper expression for time from the result of the text analysis section;
a date/time expression storage section that stores time stamp information such as a text creation date or an article posting date of the text data stored in the data storage section, or the date/time expression extracted by the time expression determination section;
a date/time calculation section that calculates an actual date/time expression to replace the proper expression for time extracted by the time expression determination section, based on the time stamp information or the date/time expression stored in the date/time expression storage section;
a feature expression extraction section that determines and extracts a feature expression which distinctively appears in the articles including the keyword from the result of the text analysis section;
a schedule information creation section that creates schedule information including a set of the date/time expression and one or more feature expressions based on an output result of the time expression determination section or an output result of the date/time calculation section, and an output result of the feature expression extraction section;
a schedule information storage section that stores a result created by the schedule information creation section; and
a schedule information display section that obtains schedule information corresponding to date and time specified by a user in the schedule information storage section, and displays it on the result visualization section.

5. A method for analyzing text information comprising the steps of:
storing data to be analyzed;
performing text analysis on text data stored;
sorting out articles including a keyword to be analyzed in a result of the text analysis;
counting a number of articles sorted out;
visualizing and presenting a result of the counting as a time series graph or the like by a result visualization section;
determining and extracting a date/time expression or a proper expression for time from the result of the text analysis;
determining and extracting a feature expression that distinctively appears in the articles including the keyword from the result of the text analysis;
creating schedule information including a set of the date/time expression and one or more feature expressions based on a result obtained by determining and extracting the time expression or the proper expression for time and on a result obtained by determining and extracting the feature expression;
storing the created schedule information;
obtaining schedule information corresponding to date and time specified by a user in the stored schedule information; and
displaying it on the result visualization section.

6. The method for analyzing text information according to claim 5, further comprising the steps of:
storing time stamp information such as a text creation date or an article posting date of the text data stored, or a date/time expression obtained by determining and extracting the date/time expression or the proper expression for time; and
calculating an actual date/time expression to replace the proper expression for time obtained by determining and extracting the date/time expression or the proper expression for time, based on the stored time stamp information or date/time expression.

7. A method for analyzing text information comprising the steps of:
storing data to be analyzed;
performing text analysis on text data stored;
sorting out articles including a keyword to be analyzed in a result of the text analysis;
counting a number of articles sorted out;
visualizing and presenting, by a result visualization section, a result of the counting as a time series graph or the like;
determining and extracting a date/time expression or a proper expression for time from the result of the text analysis;
storing time stamp information such as a text creation date or an article posting date of the text data stored, or a date/time expression obtained by determining and extracting the date/time expression or the proper expression for time;
calculating an actual date/time expression to replace the proper expression for time obtained by determining and extracting the date/time expression or the proper expression for time, based on the stored time stamp information or date/time expression;
determining and extracting a feature expression which distinctively appears in articles including the keyword from the result of the text analysis;
creating schedule information including a set of the date/time expression and one or more feature expressions based on a result obtained by determining and extracting the time expression or the proper expression for time or a result obtained by calculating and replacing the actual date/time expression, and a result obtained by determining and extracting the feature expression;
storing the created schedule information;
obtaining schedule information corresponding to date and time specified by a user in the stored schedule information; and
displaying it on the result visualization section.

8. A recording medium storing a program for text information analysis, the program causing a computer to execute:
a procedure to store data to be analyzed to a data storage section;
a text analysis procedure to perform text analysis on text data in the data storage section;
a document sort procedure to sort out articles including a keyword to be analyzed in a result of the text analysis procedure;
a document number counting procedure to count a number of articles sorted out by the document sort procedure;
a result visualization procedure to visualize and present a count result of the document number counting procedure as a time series graph or the like;
a time expression determination procedure to determine and extract a date/time expression or a proper expression for time from the result of the text analysis procedure;
a feature expression extraction procedure to determine and extract a feature expression which distinctively appears in the articles including the keyword from the result of the text analysis procedure;
a schedule information creation procedure to create schedule information including a set of the date/time expression and one or more feature expressions based on an output result of the time expression determination procedure and an output result of the feature expression extraction procedure;
a schedule information storage procedure to store a result created by the schedule information creation procedure to a schedule information storage section; and
a schedule information display procedure to obtain schedule information corresponding to date and time specified by a user in the schedule information storage section, and to display it by the result visualization procedure.

9. The recording medium storing a program for text information analysis according to claim 8, the program further causing a computer to executing:
a date/time expression storage procedure to store time stamp information such as a text creation date or an article posting date of the text data stored in the data storage section, or the date/time expression extracted by the time expression determination procedure; and
a date/time calculation procedure to calculate an actual date/time expression to replace the proper expression for time extracted by the time expression determination procedure, based on the time stamp information or the date/time expression stored in a the date/time expression storage procedure.

10. A recording medium storing a program for text information analysis, the program causing a computer to execute:
a procedure to store data to be analyzed to a data storage section;
a text analysis procedure to perform text analysis on text data in the data storage section;
a document sort procedure to sort out articles including a keyword to be analyzed in a result of the text analysis procedure;
a document number counting procedure to count a number of articles sorted out by the document sort procedure;
a result visualization procedure to visualize and present a count result of the document number counting procedure as a time series graph or the like;
a time expression determination procedure to determine and extract a date/time expression or a proper expression for time from the result of the text analysis procedure;
a date/time expression storage procedure to store time stamp information such as a text creation date or an article posting date of the text data stored in the data storage section, or the date/time expression extracted by the time expression determination procedure;
a date/time calculation procedure to calculate an actual date/time expression to replace the proper expression for time extracted by the time expression determination procedure, based on the time stamp information or the date/time expression stored by the date/time expression storage procedure.
a feature expression extraction procedure to determine and extract a feature expression which distinctively appears in the articles including the keyword from the result of the text analysis procedure;
a schedule information creation procedure to create schedule information including a set of the date/time expression and one or more feature expressions based on an output result of the time expression determination procedure or an output result of the date/time calculation procedure, and an output result of the feature expression extraction procedure;
a schedule information storage procedure to store a result created by the schedule information creation procedure to a schedule information storage section; and
a schedule information display procedure to obtain schedule information corresponding to date and time specified by a user in the schedule information storage section, and to display it by the result visualization procedure.
